(19) United States
(12) Patent Application Publication
(10) Pub. No.: US 2014/0044890 A1
(43) Pub. Date: Feb. 13, 2014

(54) METHOD FOR FABRICATING MAGNETIC GRAPHENE-BASED NANOCOMPOSITE

(71) Applicants: YONG CHIEN LING, Hsinchu City (TW); Ganesh Gollavelli, Hsinchu City (TW)

(72) Inventors: YONG CHIEN LING, Hsinchu City (TW); Ganesh Gollavelli, Hsinchu City (TW)

(21) Appl. No.: 13/607,746

(22) Filed: Sep. 9, 2012

(30) Foreign Application Priority Data
Aug. 10, 2012 (TW) 101128899

(51) Int. Cl. B05D 7/24; B82Y 30/00

(52) U.S. Cl. 427/595; 977/734

(57) ABSTRACT

A method for fabricating a magnetic graphene-based nanocomposite comprises a mixing step: placing a graphene oxide layer, an iron-containing precursor and a microwave-receiving material in a container; and a microwaving step: applying microwave radiation to the graphene oxide layer, the iron-containing precursor and the microwave-receiving material to reduce the graphene oxide layer into the reduced graphene oxide (RGO) layer and decompose the iron-containing precursor into a plurality of iron nanoparticles adhering to at least one surface of the RGO layer, whereby is formed a magnetic graphene-based nanocomposite. Via applying microwave radiation within one minute, a magnetic graphene-based nanocomposite can be fabricated, whereby is greatly decreased the time to fabricate a composite containing graphene oxide and magnetite. Therefore, the method has advantages of high efficiency and simple processes.

### FIELD OF THE INVENTION

The present invention relates to a magnetic graphene-based nanocomposite, particularly to a method for fabricating a magnetic graphene-based nanocomposite.

### BACKGROUND OF THE INVENTION

Graphene is an allotrope of carbon, which is a material formed of 2-dimensional 6-carbon hexagonal cells. Graphene features transparency, high electric conductivity, high thermal conductivity, high strength-to-weight ratio, and fine ductility. Therefore, the academia and industry have invested a lot of resources in introducing graphene into the existing electronic element fabrication processes and anticipate that graphene can promote the overall performance thereof. At present, graphene is mainly applied to transistors, electrodes of lithium batteries, photosensors, and transparent electrodes of touchscreens, LED and solar cells, etc.

A U.S. Pat. Pub. No. 2010/0237296 discloses a graphene fabrication method, which reduces a single-layer graphite oxide into graphite in a high boiling point solvent. Firstly, disperse a single-layer graphite oxide into water to form a dispersion liquid. Next, add a solvent to the dispersion liquid to form a solution. The solvent is selected from a group consisting of N-methlypyrrolidone, ethylene glycol, glycerin, dimethlypyrrolidone, acetone, tetrahydrofuran, acetonitrile, dimethylformamide, amine, and alcohol. Next, heat the solution to a temperature of about 200° C. Then, obtain single-layer graphene through a purification process. A U.S. Pat. Pub. No.2010/0323113 disclosed a graphene synthesis method, which maintains a hydrocarbon compound at a temperature of 200-600° C. to implant carbon atoms into a substrate made of a metal or an alloy. With decrease of temperature, carbon deposits and diffuses out of the substrate to form graphene layers.

Recently, a Korean research team found that a composite material containing RGO (Reduced Graphene Oxide) and magnetite (Fe₃O₄) can effectively remove arsenic dissolved in water. Further, Kwang Kim and In-Cheol Hwang et al. proposes a chemical precipitation method to fabricate a composite material containing RGO and magnetite, which can remove arsenic from water.

However, the conventional technology normally spends several hours to complete a process of fabricating a composite material containing graphene oxide and magnetite. Therefore, the conventional technology has the problem of low efficiency and limits the development and application of magnetic graphene-based composite materials.

### SUMMARY OF THE INVENTION

The primary objective of the present invention is to solve the time-consuming problem in fabricating a composite material containing graphene oxide and magnetite.

To achieve the abovementioned objective, the present invention proposes a method for fabricating a magnetic graphene-based nanocomposite, which comprises:

a mixing step: placing a graphene oxide layer, an iron-containing precursor and a microwave-receiving material in a container; and

a microwaving step: applying microwave radiation to the graphene oxide layer, iron-containing precursor and microwave-receiving material to reduce the graphene oxide layer into a reduced grapheme oxide (RGO) layer and decompose the iron-containing precursor into a plurality of iron nanoparticles adhering to at least one surface of the RGO layer, whereby is formed a magnetic graphene-based nanocomposite.

The present invention further proposes another method for fabricating a magnetic graphene-based nanocomposite, which comprises:

a mixing step: placing a plurality of stacked graphene oxide layers, an iron-containing precursor and a microwave-receiving material in a container; and

a microwaving step: applying microwave radiation to the plurality of stacked graphene oxide layers, iron-containing precursor and microwave-receiving material to reduce the stacked graphene oxide layers into a plurality of stacked RGO layers and decompose the iron-containing precursor into a plurality of iron nanoparticles adhering to at least one surface of the plurality of stacked RGO layers, whereby is formed a magnetic graphene-based nanocomposite.

Via applying microwave radiation, the present invention can fabricate the graphene oxide layers, iron-containing precursor and microwave-receiving material into a magnetic graphene-based nanocomposite within one minute. The present invention can use a simple process to effectively decrease the time of fabricating a composite containing graphene oxide and magnetite. Therefore, the present invention can benefit the industrial development of the magnetic graphene-based nanocomposite.

### BRIEF DESCRIPTION OF THE DRAWINGS

FIG. 1 shows a flowchart of a method for fabricating a magnetic graphene-based nanocomposite according to one embodiment of the present invention;

FIG. 2A schematically shows the structure of graphene according to one embodiment of the present invention;

FIG. 2B schematically shows the structure of a graphene oxide layer according to one embodiment of the present invention;

FIG. 2C schematically shows the structure of a magnetic graphene-based nanocomposite according to one embodiment of the present invention;

FIG. 3 shows the superparamagnetism of a magnetic graphene-based nanocomposite according to one embodiment of the present invention;

FIG. 4A shows the isothermal absorptivity curve of lead, chromium and arsenic with respect to a magnetic graphene-based nanocomposite according to one embodiment of the present invention;

FIG. 4B shows the isothermal absorptivity curve of bisphenol A with respect to a magnetic graphene-based nanocomposite according to one embodiment of the present invention;

FIG. 5A shows the antibiotic effect of a magnetic graphene-based nanocomposite on the colon bacilli according to one embodiment of the present invention; and

FIG. 5B shows the toxicity to the zebrafish of a magnetic graphene-based nanocomposite according to one embodiment of the present invention.

### DETAILED DESCRIPTION OF THE PREFERRED EMBODIMENTS

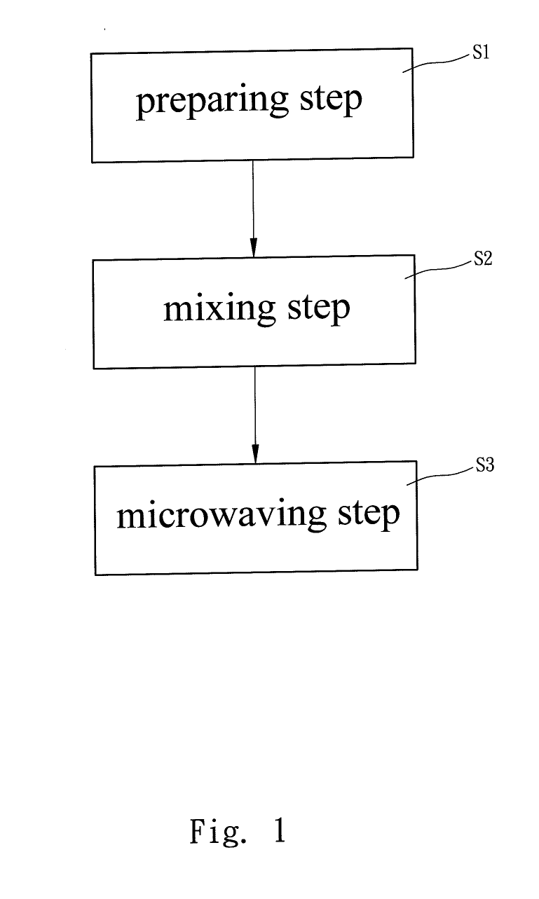

The technical contents of the present invention will be described in detail in cooperation with drawings below. Refer to FIG. 1 for a flowchart of a method for fabricating a magnetic graphene-based nanocomposite according to one embodiment of the present invention. The method of the present invention comprises a preparing step S1, a mixing step S2 and a microwaving step S3.

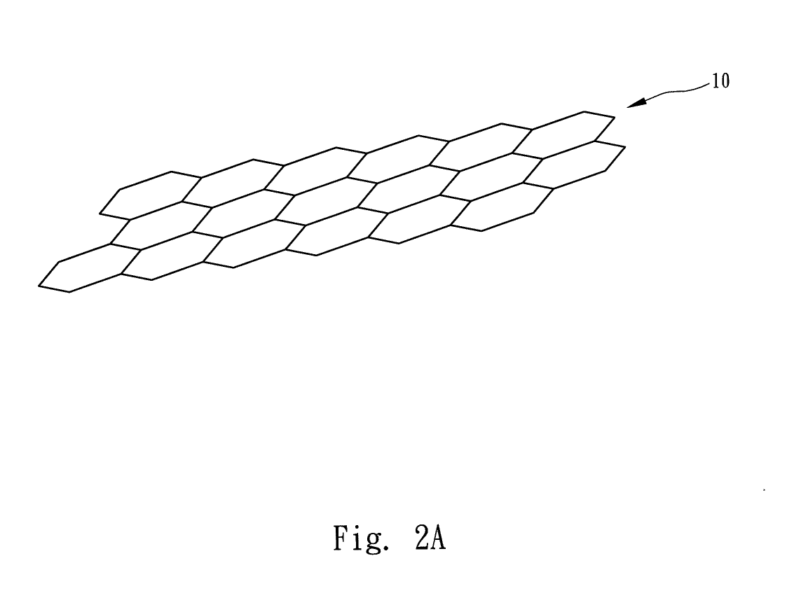

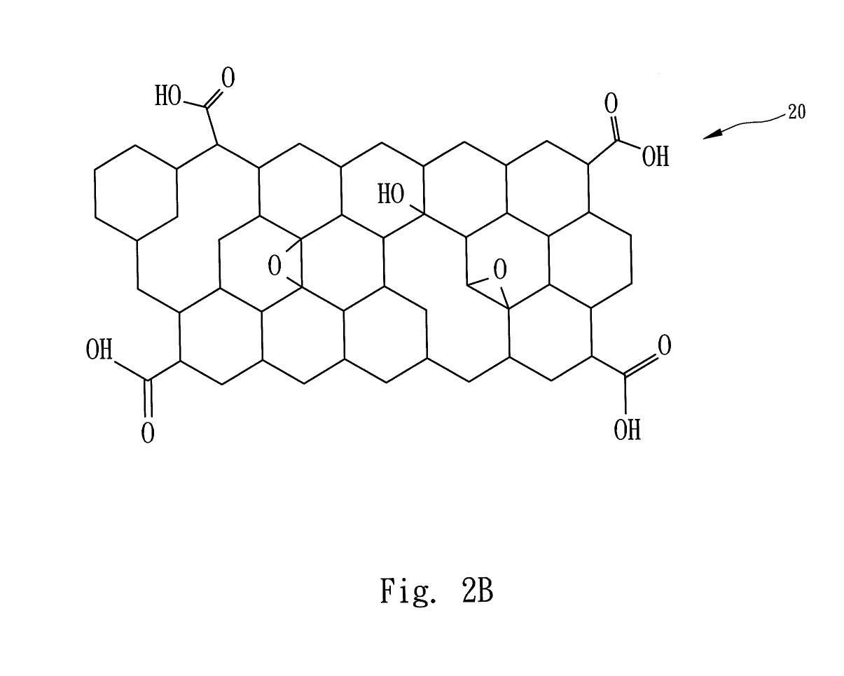

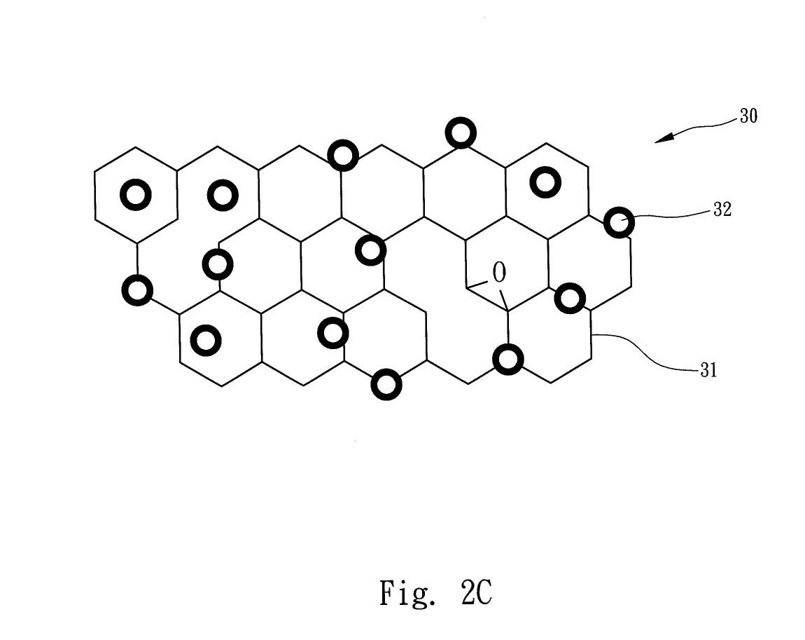

In the preparing step S1, a Hummers' method is used to fabricate graphene 10 into a graphene oxide layer 20. The carbon atom arrangement of the graphene 10 is identical to that of the single-atom thick layer of graphite, wherein the sp2 hybrid orbitals make carbon atoms form a single-atom thick crystal having a 2D honeycomb lattice. The Hummers' method uses chemical agents, such as concentrated sulfuric acid, concentrated nitric acid, and potassium permanganate, to oxidize graphene powder into graphene oxide, and next flushes the product to remove the sulfate ions until the product becomes neutral, and then ultrasonically separates the graphene oxide layers 20 from the product. For details, please refer to a paper published by W. S. Hummers and R. E. Offeman, J. Am. Chem. Soc. 80(1958), 1339. Refer to FIG. 2A and FIG. 2B which respectively show the structures of the graphene 10 and the graphene oxide layer 20. Although this embodiment uses the Hummers' method to fabricate the graphene oxide layer 20, the present invention does not constrain that the graphene oxide layer 20 should be fabricated with the Hummers' method. The graphene oxide layer 20 is illustrated with a single layer graphene oxide. However, the graphene oxide layer 20 may also be more than one. In that case, multiple graphene oxide layers are stacked together in the present invention. Besides, the preparing step S1 is not a necessary but an optional step in the present invention.

In the mixing step S2, the graphene oxide layer 20, an iron-containing precursor, and a microwave-receiving material are placed in a container. In one embodiment, the graphene oxide layer 20, iron-containing precursor, and microwave-receiving material are mixed in the container; the iron-containing precursor is in form of powder and made of ferrocene, iron carbonyl (Fe(CO)₅), or an iron-containing organometallic compound; the microwave-receiving material is debris of silicon wafers or made of copper; the container is made of a metallic material.

In the microwaving step S3, microwave radiation is applied to the graphene oxide layer 20, iron-containing precursor, and microwave-receiving material. In one embodiment, the microwave radiation having a frequency of 2.4 GHz causes the microwave-receiving material to generate electric arc; the reaction environment is heated to a temperature of 300-1000° C. to reduce the graphene oxide layer 20 into a reduced graphene oxide (RGO) layers 31 and decompose the iron-containing precursor into a plurality of iron nanoparticles 32 adhering to at least one surface of the RGO layers 31, whereby is formed a magnetic graphene-based nanocomposite 30, as shown in FIG. 2C. In this embodiment, the time of applying microwave radiation is less than 1 minute.

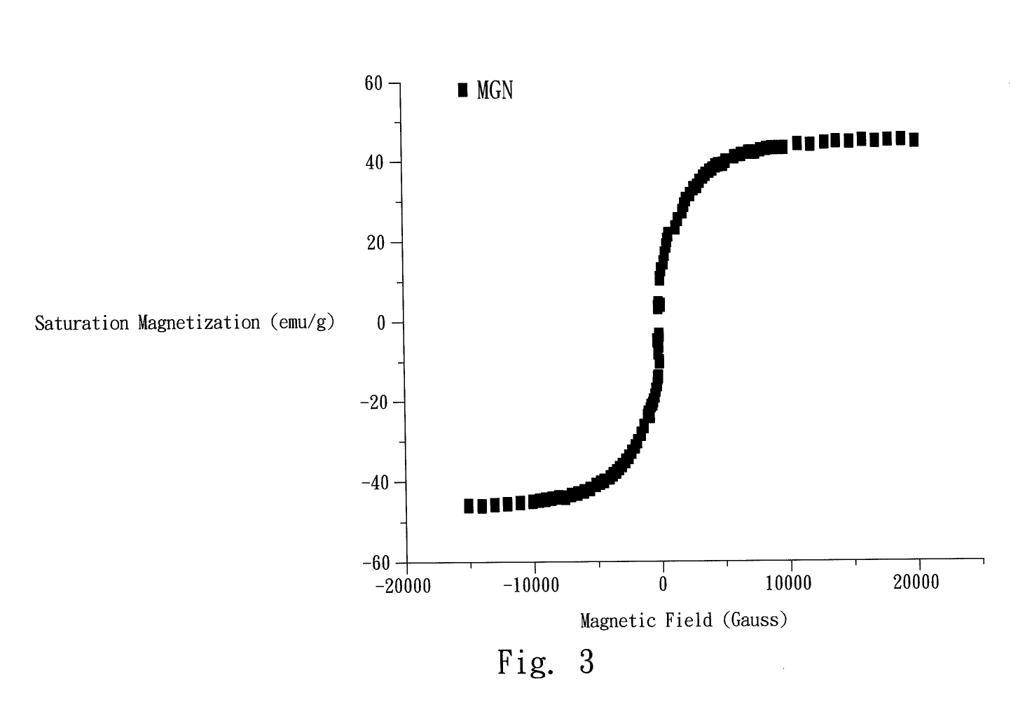

Refer to FIG. 3 showing the superparamagnetism of a magnetic graphene-based nanocomposite according to one embodiment of the present invention, wherein the horizontal axis denotes the magnetic field applied to the magnetic graphene-based nanocomposite 30, and wherein the vertical axis denotes the saturation magnetization. In one embodiment, the magnetic graphene-based nanocomposite 30 is fabricated with the graphene oxide layer 20 and the iron-containing precursor by a ratio of 1:7. SQUID (Superconducting Quantum Interference Device) detects that the magnetic graphene-based nanocomposite 30 fabricated in this embodiment possesses superparamagnetism and has a saturation magnetization of 50 emu/g.

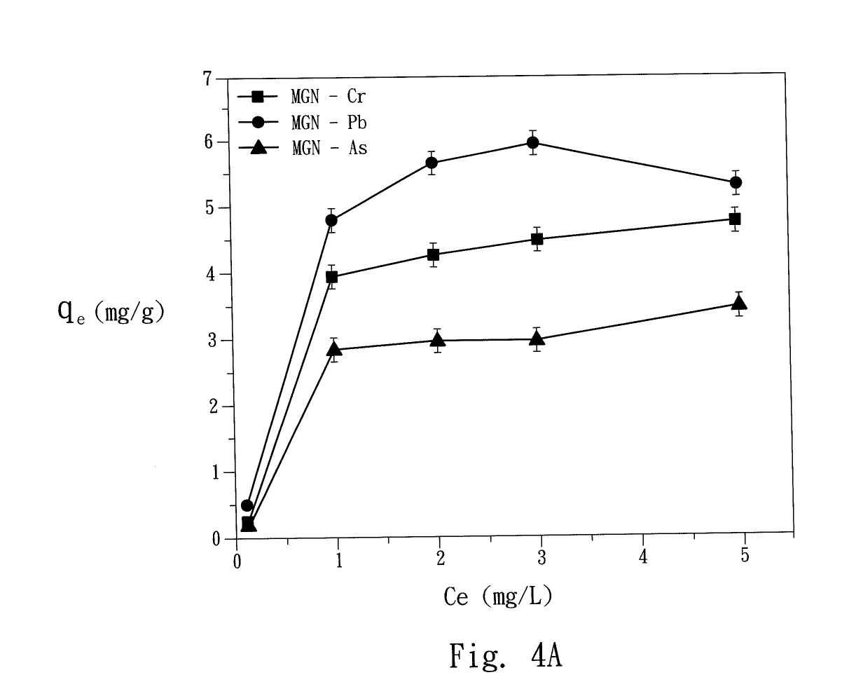

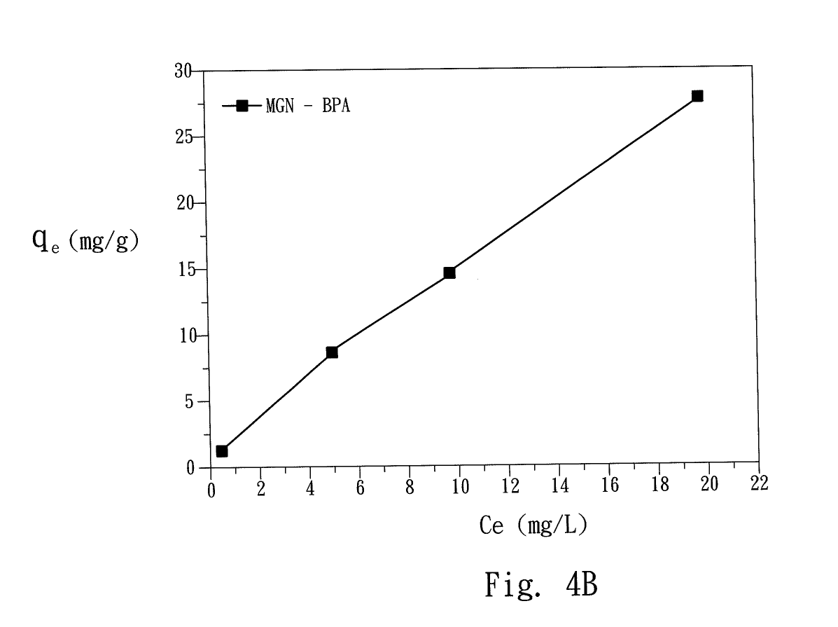

Refer to FIG. 4A and FIG. 4B respectively showing the isothermal adsorption curves of [lead, chromium and arsenic] and bisphenol A with respect to the magnetic graphene-based nanocomposite of the present invention. In FIG. 4A, the horizontal axis denotes the equilibrium concentration of the metal pollutant, and the vertical axis denotes the equilibrium weight of the pollutant adsorbed by the magnetic graphene-based nanocomposite 30. FIG. 4A proves that the magnetic graphene-based nanocomposite 30 can effectively absorb lead, chromium and arsenic. In FIG. 4B, the horizontal axis denotes the equilibrium concentration of bisphenol A, and the vertical axis denotes the equilibrium weight of bisphenol A absorbed by the magnetic graphene-based nanocomposite 30. FIG. 4B proves that the magnetic graphene-based nanocomposite 30 can effectively absorb bisphenol A (Bisphenol A, BPA). Therefore, the magnetic graphene-based nanocomposite 30 of the present invention can effectively purify water.

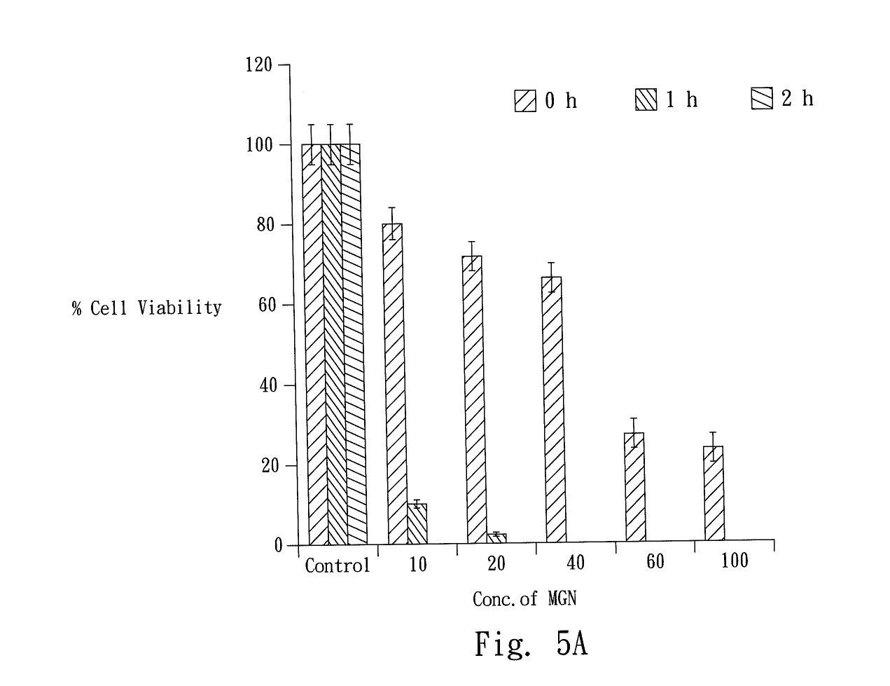

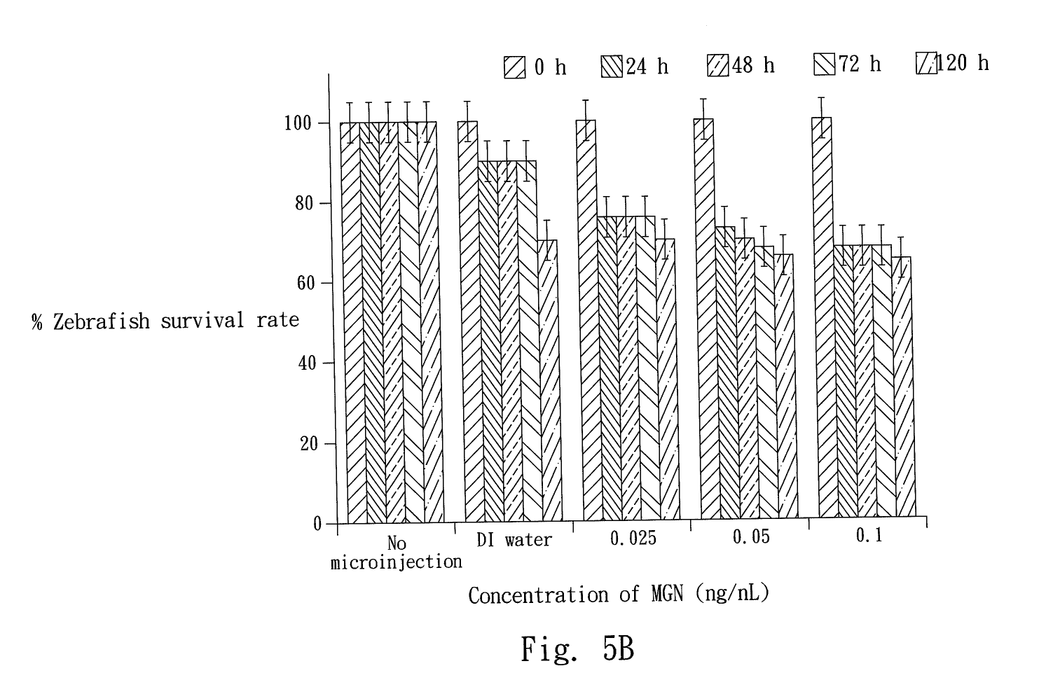

Refer to FIG. 5A showing the antibiotic effect of the magnetic graphene-based nanocomposite of the present invention on the colon bacilli. Refer to FIG. 5B showing the toxicity to the zebrafish of the nanocomposite of the present invention. FIG. 5A shows that the viability of the colon bacilli decreases when the concentration of the magnetic graphene-based nanocomposite 30 increases or when the duration that the magnetic graphene-based nanocomposite 30 contacts the colon bacilli increases. Therefore, the magnetic graphene-based nanocomposite 30 has a superior antibiotic effect. In the toxicity test, the DI water and the magnetic graphene-based nanocomposite 30 are injected into the fetuses of the zebrafish. The viabilities of the fetuses of composite injection and DI water injection are almost identical, even in the cases that the concentration of the composite is increased, as shown in FIG. 5B. Therefore, the magnetic graphene-based nanocomposite 30 does not have obvious toxicity to the zebrafish.

Via applying microwave radiation to graphene oxide layers, an iron-containing precursor and a microwave-receiving material, the present invention fabricates a magnetic graphene-based nanocomposite within 1 minute, whereby is greatly reduced the time to fabricate a composite containing graphene oxide and magnetite. Therefore, the present invention has advantages of high efficiency and simple processes. Further, the magnetic graphene-based nanocomposite has superparamagnetism and absorbs lead, chromium, arsenic and bisphenol A effectively. Therefore, the magnetic graphene-based nanocomposite can purify water via absorbing heavy metals from water. Besides, the magnetic graphene-based nanocomposite is highly antibiotic and free of toxicity. Accordingly, the present invention possesses utility, novelty and non-obviousness and meets the condition for a patent. Thus, the Inventors file the application for a patent. It is appreciated if the patent is approved fast.

The embodiments described above are only to exemplify the present invention but not to limit the scope of the present invention. Any equivalent modification or variation according to the spirit of the present invention is to be also included within the scope of the present invention.

What is claimed is:

1. A method for fabricating a magnetic graphene-based nanocomposite, comprising:
a mixing step: placing a graphene oxide layer, an iron-containing precursor, and a microwave-receiving material in a container; and
a microwaving step: applying microwave radiation to the graphene oxide layer, the iron-containing precursor and the microwave-receiving material to reduce the graphene oxide layer into a reduced graphene oxide (RGO) layer and decompose the iron-containing precursor into a plurality of iron nanoparticles adhering to at least one surface of the reduced graphene oxide (RGO) layer, whereby is formed a magnetic graphene-based nanocomposite.

2. The method for fabricating a magnetic graphene-based nanocomposite according to claim 1, further comprising a preparing step: using a Hummers' method to fabricate graphene into the graphene oxide layer before the mixing step.

3. The method for fabricating a magnetic graphene-based nanocomposite according to claim 1, wherein the microwaving step is undertaken for no more than 1 minute.

4. The method for fabricating a magnetic graphene-based nanocomposite according to claim 1, wherein the microwave radiation implements a reaction temperature of 300-1000° C.

5. The method for fabricating a magnetic graphene-based nanocomposite according to claim 1, wherein the iron-containing precursor is selected from a group consisting of ferrocene, iron carbonate, and iron-containing organometallic compound.

6. The method for fabricating a magnetic graphene-based nanocomposite according to claim 1, wherein the microwave-receiving material is silicon or copper.

7. The method for fabricating a magnetic graphene-based nanocomposite according to claim 1, wherein the magnetic graphene-based nanocomposite has superparamagnetism.

8. A method for fabricating a magnetic graphene-based nanocomposite, comprising;
a mixing step: placing a plurality of stacked graphene oxide layers, an iron-containing precursor and a microwave-receiving material in a container; and
a microwaving step: applying microwave radiation to the plurality of stacked graphene oxide layers, the iron-containing precursor, and the microwave-receiving material to reduce the plurality of stacked graphene oxide layers into a plurality of stacked reduced graphene oxide (RGO) layers and decompose the iron-containing precursor into a plurality of iron nanoparticles adhering to at least one surface of the plurality of stacked reduced graphene oxide (RGO) layers, whereby is formed a magnetic graphene-based nanocomposite.

9. The method for fabricating a magnetic graphene-based nanocomposite according to claim 8, further comprising a preparing step: using a Hummers' method to fabricate graphene into the plurality of stacked graphene oxide layers before the mixing step.

10. The method for fabricating a magnetic graphene-based nanocomposite according to claim 8, wherein the microwaving step is undertaken for no more than 1 minute.

11. The method for fabricating a magnetic graphene-based nanocomposite according to claim 8, wherein the microwave radiation implements a reaction temperature of 300-1000° C.

12. The method for fabricating a magnetic graphene-based nanocomposite according to claim 8, wherein the iron-containing precursor is selected from a group consisting of ferrocene, iron carbonyl, and iron-containing organometallic compound.

13. The method for fabricating a magnetic graphene-based nanocomposite according to claim 8, wherein the microwave-receiving material is silicon or copper.

14. The method for fabricating a magnetic graphene-based nanocomposite according to claim 1, wherein the magnetic graphene-based nanocomposite has superparamagnetism.
